(19) United States
(12) Patent Application Publication
(10) Pub. No.: US 2025/0307289 A1
(43) Pub. Date: Oct. 2, 2025

(54) OPTIMIZING PROMPT AUGMENTATION

(71) Applicant: Nokia Solutions and Networks Oy, Espoo (FI)

(72) Inventors: Frederik VANDEPUTTE, Antwerp (BE); Geert HEYMAN, Antwerp (BE)

(21) Appl. No.: 19/080,648

(22) Filed: Mar. 14, 2025

(30) Foreign Application Priority Data
Mar. 28, 2024 (FI) 20245365

(51) Int. Cl. G06F 16/334; G06F 16/3332; G06F 40/284

(52) U.S. Cl. CPC G06F 16/3346; G06F 16/3338; G06F 40/284

(57) ABSTRACT

Example embodiments describe a computer-implemented method for optimizing an augmentation of a prompt provided to a generative AI model; wherein the prompt is an input sequence of input segments respectively comprising one or more input tokens; and wherein the generative AI model is configured to generate, from the prompt, an output sequence of output segments respectively comprising one or more output tokens; the computer-implemented method comprising: obtaining at least one target output sequence for the prompt provided to the generative AI model; obtaining one or more augmented prompts by adjusting one or more input segments with respect to at least one reference prompt; determining prompt importance scores for the respective output segments of the at least one target output sequence; and optimizing the augmentation of the prompt based on the prompt importance scores of the respective output segments.

### FIELD OF THE INVENTION

Various example embodiments relate to prompt augmentation for generative AI models.

### BACKGROUND OF THE INVENTION

A generative Artificial Intelligence, AI, model generates an output from a prompt provided to it as an input. The generated output is at least partially determined by the content and structure of the input prompt. Prompt augmentation refers to enhancing the content and/or structure of an input prompt to improve or influence the generated output of a generative AI model. Typical prompt augmentation techniques rely on adding I/O examples to the input prompt, adding additional facts to the input prompt, adding formatting instructions to the input prompt, or increasing the human interpretability of the generated output by prompting the AI model to include its ‘thought process’. Common prompt augmentation techniques are, for example, few-shot prompting, show-your-work techniques, domain/fact augmentation techniques, automatic prompt engineering, and multi-agent iterative augmentation.

Existing prompt augmentation techniques have the problem that they are manual and follow a static or templated approach, which can result in irrelevant information and/or an insufficient amount of relevant information being provided to the generative AI model. It is a further problem that only limited quantitative metrics are available to objectively evaluate the effectiveness and efficiency of possible prompt augmentations.

### SUMMARY OF THE INVENTION

The scope of protection sought for various embodiments of the invention is set out by the independent claims. The embodiments and features described in this specification that do not fall within the scope of the independent claims, if any, are to be interpreted as examples useful for understanding various embodiments of the invention.

Amongst others, it is an object of embodiments of the invention to provide a quantitative metric for the objective analysis of the effectiveness and efficiency of prompt augmentation, and to optimize prompt augmentation based on this quantitative metric.

This object is achieved, according to a first example aspect of the present disclosure, by a computer-implemented method for optimizing an augmentation of a prompt provided to a generative Artificial Intelligence, AI, model. The prompt is an input sequence of input segments respectively comprising one or more input tokens; and the generative AI model is configured to generate, from the prompt, an output sequence of output segments respectively comprising one or more output tokens. The computer-implemented method comprising:
obtaining at least one target output sequence for the prompt provided to the generative AI model;
obtaining one or more augmented prompts by adjusting one or more input segments with respect to at least one reference prompt;
determining prompt importance scores for the respective output segments of the at least one target output sequence; wherein a prompt importance score of a respective output segment is indicative for a change in probability of said output segment within the output sequence generated by the generative AI model as a result of adjusting the reference prompt; and
optimizing the augmentation of the prompt based on the prompt importance scores of the respective output segments.

The input sequence and the output sequence may comprise one or more data types, e.g. text and numbers. The input sequence and the output sequence respectively comprise an ordered sequence of input tokens and output tokens. Tokens refer to frequently occurring chunks of data at a relatively fine granularity. For example, if a prompt comprises natural language text, one token may correspond to 0.75 words.

One or more input tokens within the input sequence are grouped into an input segment. An input segment thus forms a subset of the input sequence, i.e. the prompt. Input segments may group input tokens that are logically related by relating to a certain type of information included within the prompt, e.g. a specific fact, task, or example. An input segment may have any length ranging between at least one input token and all input tokens within the input sequence. The respective input segments within an input sequence may have different lengths. Alternatively, the respective input segments within an input sequence may have the same lengths.

One or more output tokens within the output sequence are grouped into an output segment. An output segment thus forms a subset of the output sequence, i.e. the output generated by the generative AI model. An output segment may have any length ranging between at least one output token and all output tokens within the output sequence. The respective output segments within an output sequence may have distinct lengths. Alternatively, the respective output segments within an output sequence may have the same lengths.

The at least one target output sequence is an ordered sequence of output tokens which is used as a reference to enable a quantitative analysis of prompt augmentation. The at least one target output sequence may, for example, be a desired output sequence for a certain application.

The output segments within an output sequence generated by the generative AI model are associated with a probability, i.e. the likelihood or confidence of a certain output segment occurring at a certain position within the output sequence. Therefore, the output segments within the at least one target output sequence each have a certain probability.

In an inventive way, the relative impact of prompt augmentation is quantified objectively by determining prompt importance scores for the respective output segments of the at least one target output sequence. A prompt importance score of a respective output segment is indicative for a change in probability of said output segment within the output sequence generated by the generative AI model as a result of adjusting a reference prompt, i.e. as a result of prompt augmentation.

To this end, one or more input segments of at least one reference prompt are adjusted and the effect or impact of those adjustments on the probabilities of the output segments of the output sequence are quantified. Adjusting the at least one reference prompt may include adding, removing, replacing, or reordering one or more input segments with respect to the reference prompt input sequence. The at least one reference prompt may be any input sequence.

The prompt importance scores allow quantitatively and objectively determining the effectiveness of the ordered input segments within the prompt with respect to the generated output. This quantitative metric of augmentation effectiveness allows effective optimization of the augmentation of a prompt by limiting the amount of low-impact input segment within the prompt and by supplementing the prompt with high-impact information. Limiting low-impact input segments in the prompt has the advantage that the length of prompts can be reduced, thereby reducing the amount of compute resources needed for executing the generative AI model. Supplementing prompts with high-impact information has the advantage that it can result in fewer iterations of the generative AI model to arrive at the final output, also reducing the required computing resources. It is a further advantage that the optimized prompt augmentation can enable smaller generative AI models to be used, or can enable generative AI models with a smaller context size, thereby further reducing resource consumption and improving efficiency.

According to an example embodiment, the at least one target output sequence may be a configuration instruction for configuring a network node or a controller.

The augmentation of a prompt may thus be optimized such that a generative AI model can be used to generate formatted instructions to configure a device such as, for example, a network node or a controller. This has the advantage that a generative AI model can be used to generate such a configuration instruction without being developed and designed specifically for generating configuration instructions for said device.

According to an example embodiment, the at least one target output sequence may be a formatted query for interacting with a queryable system.

In doing so, the augmentation of a prompt may be optimized such that the generative AI model can be used to generate formatted queries for interacting with a queryable system, e.g. a database. This has the advantage that a generative AI model can be used to generate the formatted queries that has not been developed and designed specifically for generating queries. For example, a general-purpose language model may be used to convert a natural language prompt to an SQL query by means of the computer-implemented method.

According to an example embodiment, determining the prompt importance scores may comprise, for each augmented prompt:
providing the augmented prompt and the at least one target output sequence to the generative AI model; and
obtaining the probabilities for the respective output segments of the target output sequence by extracting a measure of predicted likelihood associated with the respective output segments from the generative AI model.

Each of the one or more augmented prompts may thus be joined together with the at least one target output sequence and sent to the generative AI model to determine the probabilities for the respective output segments of the target output sequence. The measure of predicted likelihood associated with the respective output segments may for example be logits of the final output layer of the generative AI model, or the SoftMax of those logits. The used measure of predicted likelihood and how it is extracted depends on the architecture of the generative AI model.

In case of a decoder-only generative AI model for example, the augmented prompt and target output sequence may be merged into one large input sequence and fed as such to the generative AI model. In case of an encoder-decoder generative AI model for example, the augmented prompt is provided to the encoder and the target output sequence may be provided to the decoder. In both cases, the probabilities of the target output tokens can then be obtained by, for example, triggering a ‘forward’ call of the generative AI model, or by instructing the generative AI model to generate a single output token. The probabilities of each of the target output tokens can then be extracted, e.g. directly from the SoftMax of the logits within the generative AI model, or by reading out the token (log) probabilities via an API.

According to an example embodiment, the prompt importance score of a respective output segment may be determined as the complement of a ratio of the probability of said output segment when providing the augmented prompt to the generative AI model, relative to the probability of said output segment when providing the reference prompt to the generative AI model.

The prompt importance score of an output segment is thus indicative for the relative difference in probability of the target output segment, given some prompt input sequence, compared to the probability of that same output segment, given some reference prompt input sequence. In other words, the prompt input score measures the relative impact of one or more prompt input mutations of the reference prompt.

According to an example embodiment, the prompt importance score of a respective output segment may be determined as an absolute difference between the probability of said output segment when providing the reference prompt to the generative AI model and the probability of said output segment when providing the augmented prompt to the generative AI model.

According to an example embodiment, the prompt importance score of a respective output segment may be determined as the relative probability of said output segment with respect to the highest probability of said output segment.

According to an example embodiment, adjusting one or more input segments with respect to a reference prompt may comprise omitting and/or reordering the one or more input segments of the reference prompt.

According to an example embodiment, adjusting one or more input segments with respect to a reference prompt may comprise sampling one or more input segments from a set of possible input segments; and adding or replacing the one or more input segments of the reference prompt with the one or more sampled input segments.

The set of possible input segments may comprise all input segments from which a valid prompt input sequence can be constructed. Adjusting the reference prompt may thus comprise selecting such an input segment from the set of possible input segments and subsequently adding it at any location within the ordered reference prompt, i.e. appending the selected input segment to the reference prompt or inserting the selected input segment at any location within the reference prompt. Alternatively, the selected input segment may replace one or more input segments of the reference prompt.

According to an example embodiment, the computer-implemented method may further comprise determining an effectiveness of input segments based on the prompt importance scores; wherein the effectiveness of an input segment is indicative for the number of input tokens that are included within the input segment relative to the number of output tokens affected by augmenting the input segment and the change in prompt importance score of these affected output tokens.

In other words, the effectiveness of an input segment may be indicative for the extent that a certain input segment influences or impacts the output sequence generated by the generative AI model.

According to an example embodiment, the computer-implemented method may further comprise determining whether to perform optimizing the augmentation of the prompt based on the effectiveness of the respective input segments in the prompt provided to the generative AI model.

The effectiveness of the respective input segments may further be used to determine the number of augmented prompts and the number of target output sequences that are needed for optimizing the augmentation of the prompt.

According to an example embodiment, optimizing the augmentation of the prompt may comprise at least one of improving the selecting of input segments from a set of possible input segments, improving the formatting of the input segments, improving the order of input segments in the input sequence of the prompt; tuning a model for generating an input segment; and/or initiating a model for generating an input segment.

According to an example embodiment, the at least one target output sequence may be the output sequence generated by the generative AI model when provided with the reference prompt, or the at least one target output sequence is a desired output sequence.

According to an example embodiment, the reference prompt may be a user provided prompt, an empty prompt, and/or a complete prompt comprising an ordered sequence of all input segments in a set of possible input segments wherefrom a prompt can be constructed.

The complete prompt thus comprises all input segments within the set of possible input segments in a certain order. The empty prompt may be comprised of zero input segments. The user provided prompt may, for example, be an initial non-augmented prompt that is generated by a human or a system.

According to an embodiment, the input segments may be semantically labelled sets of ordered input tokens.

Input segment may be labelled or annotated manually or automatically with a semantic label or classification to indicate what type of information is included within the input segment. Example labels include, amongst others, formatting instruction, task description, I/O example, knowledge fact, and definition.

According to an example embodiment, the generative AI model is a generative language model, LM.

According to a second example aspect, the invention relates to a data processing system configured to perform the computer implemented method according to the first aspect.

According to a third example aspect, the invention relates to a computer program comprising instructions which, when the program is executed by a computer, cause the computer to perform the computer implemented method according to the first aspect.

According to a fourth example aspect, the invention relates to a computer-readable medium comprising instructions which, when executed by a computer, cause the computer to perform the computer implemented method according to the first aspect.

### BRIEF DESCRIPTION OF THE DRAWINGS

FIG. 1 shows an example of a generative artificial intelligence, AI, model configured to generate an output sequence when provided with an input sequence;

FIG. 2 shows steps of a computer-implemented method for optimizing an augmentation of a prompt based on prompt importance scores according to example embodiments;

FIG. 3 shows example embodiments to extract a measure of predicted likelihood from a generative AI model with an encoder-decoder architecture and a decoder-only architecture;

FIGS. 4a and 4b show an example embodiment of the computer-implemented method for optimizing an augmentation of a prompt to generate a formatted query for interacting with a queryable system;

FIG. 5 shows a prompt augmentation optimization loop based on the prompt importance scores according to example embodiments; and

FIG. 6 shows a suitable computing system 600 enabling to implement embodiments of the computer-implemented method for optimizing an augmentation of a prompt.

### DETAILED DESCRIPTION OF EMBODIMENT(S)

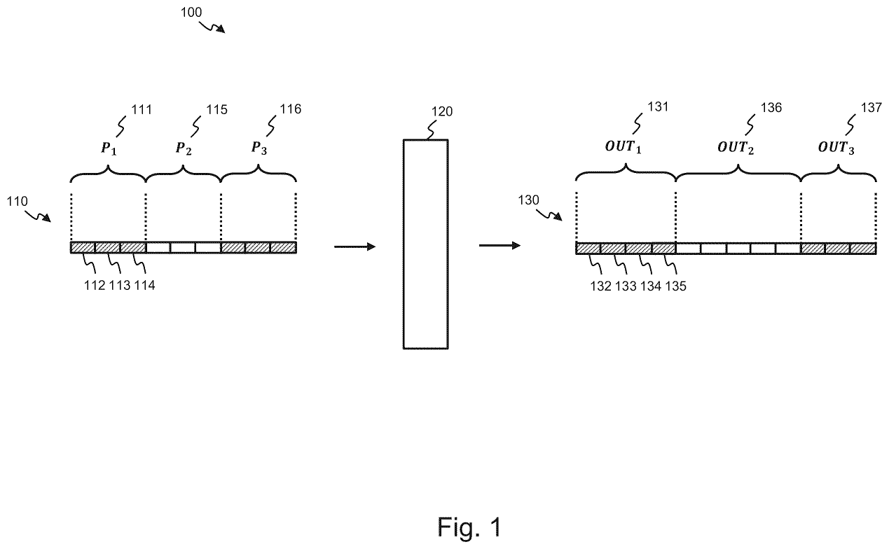

FIG. 1 shows an example of a generative artificial intelligence, AI, model 120 according to embodiments. The generative AI model 120 is configured to generate an output sequence 130 when provided with a prompt 110 as an input. Prompt 110 is an input sequence of input segments 111, 115, 116. The input segments 111, 115, 116 respectively comprise one or more input tokens 112, 113, 114. Tokens refer to frequently occurring chunks of data at a relatively fine granularity. For example, when the prompt 110 includes natural language text, one token may correspond to about 0.75 words. An input segment 111, 115, 116 thus forms a subset of the input sequence 110, i.e. the prompt.

An input segment 111, 115, 116 may have any length ranging between at least one input token and all input tokens within the input sequence 110. In other words, at the finest granularity, an input segment corresponds to a single input token and at the largest granularity an input segment corresponds to the entire prompt 110. FIG. 1 illustrates an example input sequence 110 with input segments 111, 115, 116 of equal lengths, i.e. each comprising three input tokens. Alternatively, the respective input segments 111, 115, 116, or at least some of the input segments, may have different lengths. Input segments 111, 115, 116 may group input tokens that are logically related by their association to a specific type of information included within the prompt, e.g. a specific fact, task, or example.

These input segments 111, 115, 116 may be labelled or annotated with a semantic label or classification to indicate what type of information is included within the input segment. This labelling may be performed manually, e.g. by a user providing the prompt, or automatically, e.g. by performing a classification task on a user provided prompt. Input segments 111, 115, 116 may thus be semantically labelled sets of ordered input tokens. These labels may for example include, amongst others, formatting instruction, task description, I/O example, knowledge fact, and definition.

Similarly, the output sequence 130 generated by the generative AI model 120 is a sequence of output segments 131, 136, 137 respectively comprising one or more output tokens 132, 133, 134, 135. An output segment 131, 136, 137 thus forms a subset of the output sequence 130. FIG. 1 illustrates an example output sequence 130 with output segments 131, 136, 137 of different lengths, i.e. respectively comprising 4, 5, and 3 output tokens. Alternatively, the respective output segments 131, 136, 137, or at least some of the output segments, may have the same length. The output segments 131, 136, 137 within an output sequence 130 generated by the generative AI model 120 are associated with a probability, i.e. the likelihood or confidence of a certain output segment 131, 136, 137 occurring at a certain position within the output sequence 130. For example, the probability of output segment 131 comprising tokens 131, 133, 134, 135 at the first position within the output sequence may be 80%.

The input sequence 110 and the output sequence 130 may comprise one or more data types, e.g. text, numbers, and symbols. The quality and effectiveness of the generated output 130 is at least partially determined by the content and structure of the provided prompt 110. Prompt augmentation refers to enhancing the content and/or structure of input sequence 110 to improve or influence the generated output 130 in a desired way. Typical prompt augmentation techniques rely on adding I/O examples to the input prompt, adding additional facts to the input prompt, adding formatting instructions to the input prompt, or increasing the human interpretability of the generated output by prompting the AI model to include its ‘thought process’. Common prompt augmentation techniques are, for example, few-shot prompting, show-your-work techniques, domain/fact augmentation techniques, automatic prompt engineering, and multi-agent iterative augmentation.

Existing prompt augmentation techniques have the problem that they are manual and follow a static or a templated approach, which can result in irrelevant information and/or an insufficient amount of relevant information being provided to the generative AI model 120. Providing irrelevant or superfluous information within the prompt 110 has the drawback that it increases the computing resources required to run the generative AI model 120. Providing insufficient relevant information within the prompt 110 has the drawback that it reduces the effectiveness of the generated output 130 and/or increases the iterations needed by the generative AI model 120 to arrive at the final output thereby increasing the computing resources to run the model. It is a further problem that only limited quantitative metrics are available to objectively evaluate the effectiveness and efficiency of possible prompt augmentations. It is thus desirable to enable a quantitative analysis of the effectiveness and efficiency of prompt augmentation, and to optimize prompt augmentation based on such a quantitative analysis.

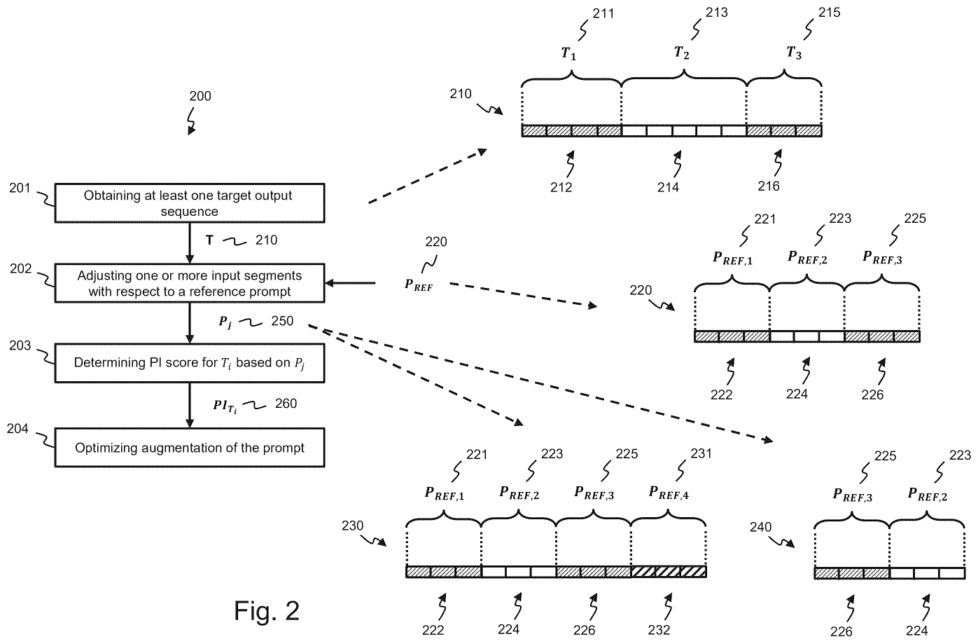

FIG. 2 shows steps 200 of a computer-implemented method for optimizing an augmentation of a prompt based on prompt importance scores 260, i.e. an objective performance metric. In a first step 201, at least one target output sequence 210 is obtained. The target output sequence 210 is an ordered sequence of output segments 211, 213, 215 which is used as a reference to enable a quantitative analysis of prompt augmentation. The output segments 211, 213, 215 may be labelled or marked by the generative AI model, e.g. by generating a predetermined header. The output segments 211, 213, 215 of the target output sequence 210 can have any length of tokens. It will be apparent that multiple target output sequences 210 can be obtained and that, in this case, steps 202-203 may be performed for each of the multiple target output sequences.

The target output sequence 210 may be a desired output sequence for a certain application towards which the importance of input segments in a prompt should be analysed and/or optimized. For example, if the generative AI model is configured to generate SQL queries based on natural language prompts, the target output sequence may be a formatted SQL query. Alternatively, the target output sequence 210 may be the output that is generated by the generative AI model when provided with a reference prompt 220 as an input.

The reference prompt 220 is an ordered input sequence of input segments 221, 223, 225 which is used as a reference to enable a quantitative analysis of prompt augmentation. The reference prompt 220 may be a prompt provided by a user without any additional prompt augmentation. Alternatively, the reference prompt 220 may be an empty prompt comprised of zero input segments. Alternatively, the reference prompt 220 may be a complete prompt comprising an ordered sequence of all input segments in a set of possible input segments wherefrom a prompt can be constructed. A complete prompt thus comprises all input segments within the set of possible input segments in a certain order. The reference prompt 220 may be static or dynamic during the optimizing of the augmentation of the prompt.

In a next step 202 of the computer-implemented method, one or more augmented prompts 230, 240 are obtained by adjusting or mutating one or more input segments with respect to the reference prompt 220. In other words, adjustments or changes are made to the input segments 221, 223, 225 of the reference prompt 220. This adjusting may comprise omitting and/or reordering one or more input segments 221, 223, 225 of the reference prompt 220. For example, augmented prompt 240 is obtained by omitting segment 221 and reordering segments 223 and 225 with respect to the reference prompt 220.

Alternatively or complementary, the adjusting 202 of the reference prompt 220 may comprise sampling one or more input segments from a set of possible input segments and adding the sampled input segments to the reference prompt 220. The set of possible input segments may comprise all input segments from which a valid prompt input sequence can be constructed. Adjusting the reference prompt 220 may thus comprise selecting an input segment from the set of possible input segments and subsequently adding it at any position within the ordered reference prompt 220. Adding a sampled input segment can be achieved by appending the selected input segment, e.g. 231, to the reference prompt 220 as illustrated by augmented prompt 230. Adding a sampled input segment can also be achieved by inserting the selected input segment at any position within the reference prompt.

Alternatively or complementary, the adjusting 202 of the reference prompt 220 may comprise sampling one or more input segments from the set of possible input segments and replacing one or more input segments 221, 223, 225 with the sampled input segments.

Obtaining augmented prompts 230, 240 may further include sampling one or more adjustment types from a set of possible adjustments. Adjustment types within the set of possible adjustments may, for example, include omitting one or more input segments, reordering one or more input segments, adding one or more input segments, or replacing one or more input segments. Thus, a list of augmented prompts 230, 240, 250 may be obtained by sampling adjustments or mutations from the set of possible adjustments in addition to sampling input segments from the set of possible input segments.

The sampling method for sampling the set of possible adjustments and the set of possible input segment may be fixed, manual, user-driven, content-driven, iterative, feedback driven, learned, or any combination thereof. It may further be based on existing search space exploration algorithms and pruning methods using some search space optimization metric. fixed, manual, user-driven, content-driven, iterative, feedback driven, learned. An example objective is to keep the number of augmented prompts 230, 240 as small as possible to minimize the overhead of needing to evaluate many different prompts. Similarly, the adjustments or mutations to evaluate should be sampled carefully to minimize overhead. It will further be apparent that a plurality of reference prompts 220 may be adjusted to obtain augmented prompts.

In a following step 203, prompt importance scores are determined for the respective output segments 211, 213, 215 of the target output sequence 210. The prompt importance score of an output segment 211, 213, 215 is indicative for a change in the probability of the output segment 211, 213, 215 as a result of adjusting the reference prompt 220. In other words, a prompt importance score expresses the change in the probability of an output segment 211, 213, 215 within the target output sequence 210 as a result of providing the generative AI model with an augmented prompt 230, 240 compared to providing the generative AI model with the reference prompt 220. Thus, the prompt importance score is indicative for the relative impact of the adjustments made to reference prompt 220 to obtain the respective augmented prompt 230, 240 on the probability of the output segments 211, 213, 215 of the target output 210.

The prompt importance scores therefore allow quantitatively and objectively determining the effectiveness of the ordered input segments within a prompt with respect to the generated output. For example, an augmented prompt may be obtained by omitting segment 223 from reference prompt 220. By comparing the probabilities of the output segments 211, 213, 215 when providing the generative AI model with such augmented prompt and providing it with the reference prompt 220, the relative prompt importance of input segment 223 onto each of the generated output segments can be determined.

To this end, the probabilities of the respective output segments 211, 213, 215 of the target output sequence 210 should be obtained. This can be achieved by providing an augmented prompt 230, 240 and the reference prompt 220 to the generative AI model; and by extracting a measure of predicted likelihood associated with the respective output segments 211, 213, 215 of the target output sequence from the generative AI model. This can be achieved by joining each of the one or more augmented prompts with the at least one target output sequence and sending the joined sequence to the generative AI model to determine the probabilities for the respective output segments of the target output sequence.

The extracted measure of predicted likelihood associated with the respective output segments may for example be logits of the final output layer of the generative AI model, or the SoftMax of those logits. The extracted measure of predicted likelihood and how it is extracted depends on the architecture of the generative AI model.

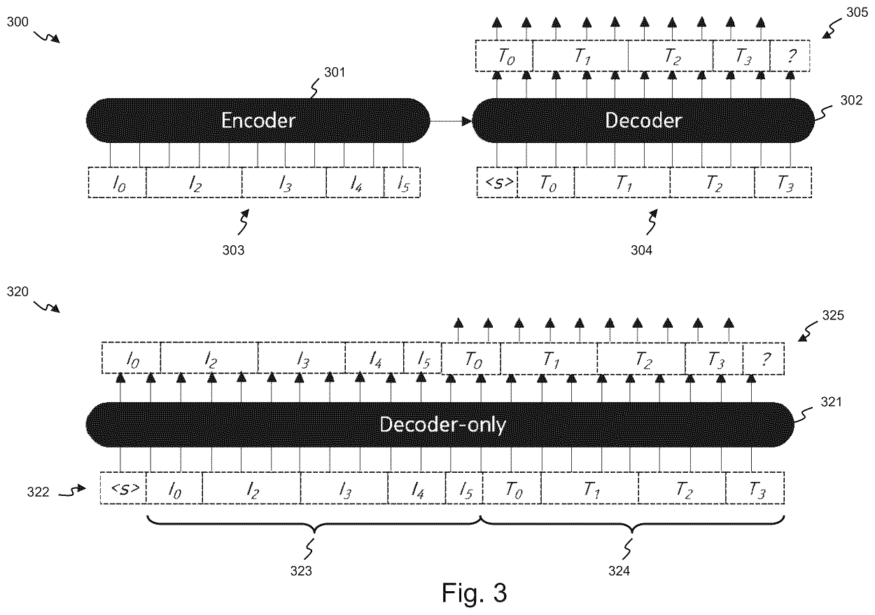

FIG. 3 shows an example of how the measure of predicted likelihood can be extracted in a generative AI model with an encoder-decoder architecture 300 and a decoder-only architecture 320. In case of the decoder-only generative AI model 321, the augmented prompt 323 and target output sequence 324 may be merged into one large input sequence 322 and provided as an input to the generative AI model 321. In case of an encoder-decoder generative AI model 300, the augmented prompt 303 is provided to the encoder 301 and the target output sequence 304 may be provided to the decoder 302. In both cases 300, 320, the probabilities of the target output tokens can then be obtained by, for example, triggering a ‘forward’ call of the generative AI model, or by instructing the generative AI model to generate a single output token. The probabilities of each of the target output tokens can then be extracted, e.g. directly from the SoftMax of the logits within the generative AI model, or by reading out the token (log) probabilities via an API. The extracted probabilities of the output tokens may further be used to determine the probabilities of output segments comprising one or more of those output tokens.

After extracting the probabilities of each output segment of the target output sequence, the prompt importance score may be determined. The prompt importance score PI_{T}_{ᵢ} of a respective output segment Tᵢ in the target output sequence T 210 may be determined as follows:

$${PI}_{{T}_{i}} = 1 - \frac{P ( {T}_{i} \vert {P}_{j} )}{P ( {T}_{i} \vert {P}_{REF} )} \qquad ( Eq . 1 )$$

wherein P(Tᵢ|Pⱼ) represents the probability of said output segment Tᵢ when providing an augmented prompt 250 Pⱼ to the generative AI model, and P(Tᵢ|P_{REF}) represents the probability of said output segment Tᵢ when providing the reference prompt 220 P_{REF} to the generative AI model.

Alternatively, the prompt importance score PI_{T}_{ᵢ} of a respective output segment Tᵢ in the target output sequence T 210 may be determined as an absolute difference between the probability of output segment Tᵢ when providing the reference prompt to the generative AI model, i.e. P(Tᵢ|P_{REF}), and the probability of said output segment Tᵢ when providing the augmented prompt to the generative AI model, i.e. P(Tᵢ|Pⱼ). In other words, the prompt importance score may be determined as

$${PI}_{{T}_{i}} = P ( {T}_{i} \vert {P}_{REF} ) - P ( {T}_{i} \vert {P}_{j} ) \qquad ( Eq . 2 )$$

Alternatively, the prompt importance score PI_{T}_{ᵢ} of a respective output segment Tᵢ in the target output sequence T 210 may be determined as the relative probability of an output segment Tᵢ with respect to the highest probability of an output segment T_{i,max} at the same position within the generated output sequence.

The resulting prompt importance scores may have positive or negative values. For example, if for some target output segment the generative AI model was not impacted by a certain input segment in the reference prompt, then removing that input segment from the reference prompt should not significantly impact the probability of that target output segment. As a result, the ratio of both probabilities in Eq. 1 above will be close to 1, resulting in a prompt importance score close to 0. This indicates quantitatively that the aforementioned input segment was not important for generating that target output segment, and thus might be superfluous for generating a good output.

In another example, if the generative AI model is strongly biased by a certain input segment for some target output segment, then removing that input segment from the reference prompt will have a strong impact on the probability by the generative AI model of that target output segment. More specifically, the probability of the target output segment P(Tᵢ|Pⱼ) will have a value around 0, which results in an importance score of around 1. This indicates quantitatively that the aforementioned input segment is important for generating that target output segment, and thus is highly relevant for generating a good output.

The prompt importance score as defined above can also return a negative value for an output segment. This can happen when an adjustment or mutation of the reference prompt had a positive impact on the probability of that output segment with respect to the reference prompt input sequence. For example, if removing some prompt input segment has a negative prompt importance score, this means that having that input segment in the reference prompt input sequence was actually counter-productive in the first place. This is very relevant information for further optimization steps, especially during the development phase.

In a final step 204 of the computer-implemented method, the augmentation of the prompt is optimized based on the determined prompt importance scores 260. Optimizing the augmentation may include optimizing the prompt template structure, adjusting the relative weight of input segments, adjusting modules used as part of the prompt augmentation, and/or changing the generative AI model. Optimizing may further include learning patterns or relationships between the input segments, adjustments to those input segments, and the generated output segments based on the prompt importance scores.

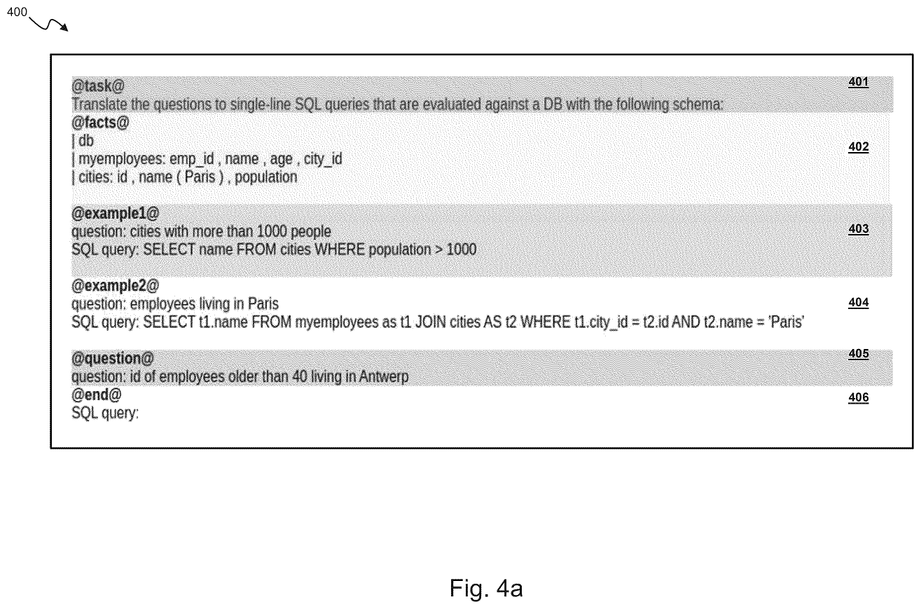

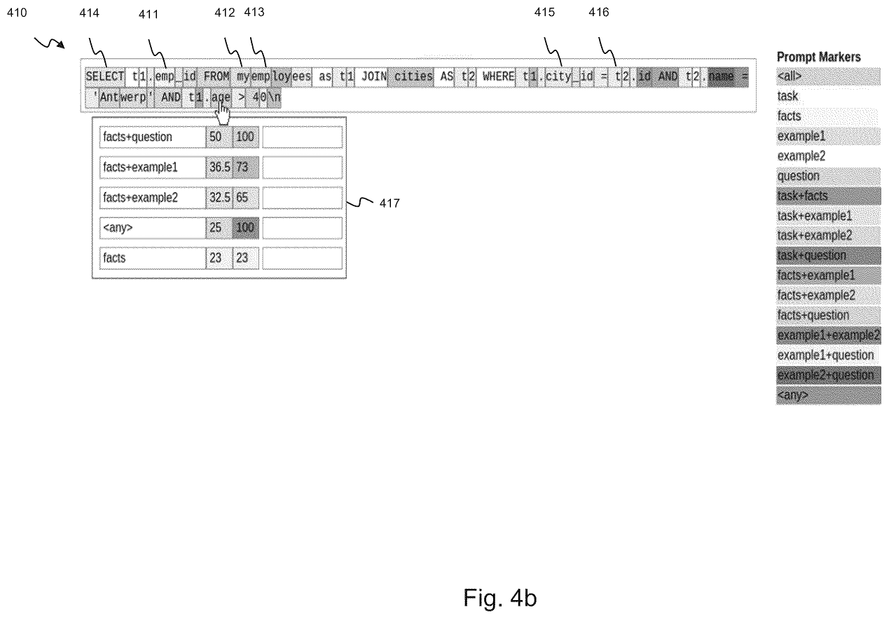

FIGS. 4a and 4b show an example embodiment of the computer-implemented method for optimizing an augmentation of a prompt to generate a formatted query for interacting with a queryable system, e.g. an SQL query for interacting with a database. The prompt 400 comprises semantically labelled input segments 401-406, respectively comprising input tokens which together form an ordered input sequence. In this example, input segment 401 is labelled as a task description, input segment 402 is labelled as a knowledge fact, input segments 403 and 404 are labelled as I/O example, input segment 405 is labelled as a question description, and input segment 406 is labelled as a formatting instruction.

This example prompt 400 may be provided to a generative AI model such as a capable large language model, LLM, to generate a formatted query from the natural language prompt 400. Such a formatted query may then be used to subsequently query some queryable system. In this specific example, the llama2-13b-chat model is used as the generative AI model. In order to use such a LLM that has not been finetuned specifically for generating formatted queries or the queryable system, prompt augmentation optimization according to the present invention may be leveraged to identify the optimal information to be included within the prompt 400.

To this end, the relative importance of each of the input segments 401-406 with respect to the output tokens or output segments can be analysed by determining the prompt importance score as described in relation to FIG. 2 above. In this case, as illustrated by 410, the target output sequence may be a formatted query for interacting with a queryable system. FIGS. 4a and 4b further illustrate how the target output sequence can be annotated with the determined prompt importance scores.

In particular, FIGS. 4a and 4b depict an example interactive visual overlay 410 of the prompt importance score onto the SQL query that was generated by the LLM. In this example overlay 410, the prompt importance score is presented for each output token generated by the LLM, i.e. at the finest granularity. The analysis may be extended towards larger output segments comprising more than one token, as discussed above, by aggregating the per-token importance score for each output segment using information theoretic methods such as, for example, weighted average, maximum, or minimum.

In this example, most of the generated output tokens are strongly biased by one or more input segments 401-406. For example, the generation of the ‘emp’ token 411 appears to be strongly biased or influenced by the database schema provided as prompt augmentation information within input segment 402 labelled as a knowledge fact. In other words, the prompt importance score indicates that the LLM relied on the database schema within that input segment 402 to predict the beginning of the exact name of the id field, i.e. ‘emp’.

Some output tokens in this example appear to be biased only by the original natural language input question within input segment 405, e.g. the four tokens forming the output segment ‘Antwerp’. Other output tokens are influenced by multiple input segments. For example, the two tokens 412, 413 forming the ‘myemp’ output segment have been biased by both the database schema within input segment 402 as well as the second I/O example within input segment 404. Some output tokens 414, 415, 416 have a very low prompt importance score indicating that none of the input segments 401-406, or any combination thereof, has a substantial impact on the LLM for producing these tokens. In these cases, the internal knowledge of the LLM, as well as all output tokens generated thus far, were sufficient for producing these output tokens. This may indicate that the LLM has been trained on some SQL queries and therefore has at least some knowledge about relevant semantic SQL patterns & grammar rules.

The prompt importance score further allows ranking which prompt input sequences 401-406 have the highest impact on a particular output token. For example, table 417 shows the top five prompt input segments for the ‘age’ output token. In this example, removing both the ‘facts’ input segment 402 and the ‘question’ input segment 405 have the most impact on the ‘age’ output token, i.e. the prompt importance score is 100%. Note that this also seems to indicate that the LLM had sufficient information to predict this token, at that point while generating the output, when only removing the ‘facts’ or ‘question’. The ‘facts’ input segment 402 only has a mild 23% prompt importance score, and ‘question’ had an even lesser 17% prompt importance score (not shown), which indicates that the LLM would be about 20% less confident about the probability of the ‘age’ token at that position without the ‘facts’ or ‘question’ input segment.

In a similar manner, the computer-implemented method can be used for optimizing an augmentation of a prompt to generate a configuration instruction for configuring a device, e.g. a network node, a network controller, or any other system controller. In this case, the target output sequence may be a configuration instruction for configuring such a device to optimize a prompt augmentation for such purpose. The optimized augmented prompt may thereafter be provided to a generative AI model such as a capable large language model, LLM, to generate a configuration instruction from, for example, a natural language prompt. Such a configuration instruction may then be used to subsequently configure a device such as a network node, a network controller, or another system controller.

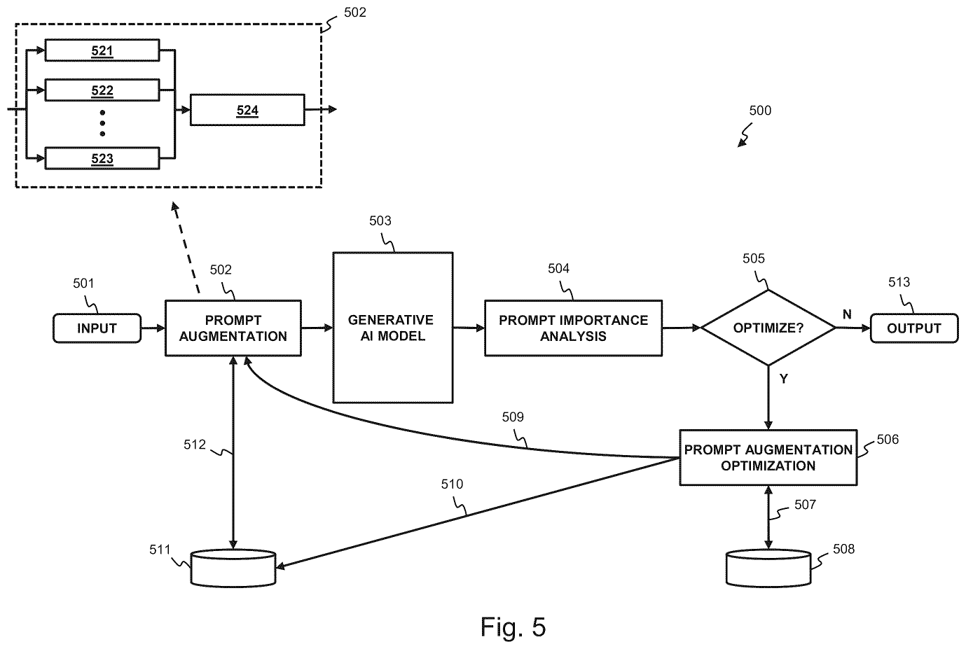

FIG. 5 shows an example embodiment of a prompt augmentation optimization loop 500 based on the prompt importance scores that allows quantitatively analysing and optimizing the information added during prompt augmentation. The prompt augmentation optimization loop 500 comprises a generative AI model 503 that is provided with an input 501, i.e. a prompt. This may, for example, be a user-provided prompt during the deployment phase of the generative AI model 503. The input prompt 501 may then be augmented by an augmentation module 502. The augmentation module 502 may, for example, comprise a plurality of augmentation modules 521-523 and a selection module 524. Each of the augmentation modules 521-523 may be configured to augment the input prompt 501 in a specific manner, e.g. adding input segments with specific domain knowledge, extracting information, adding input segments with facts based on extracted information, and generating and adding I/O examples. Augmentation modules 521-523 may thus each represent a software model or script for augmenting prompt 501 in a certain manner. The input segments that are generated by the modules 521-523 may then be provided to selection module 524 configured to select and order the generated segments into the ordered input sequence. This augmented prompt may then be provided to the generative AI model 503 as an input, which generates an output sequence in response.

This output sequence may then be analysed by a prompt importance score analysis module 504 which determines the prompt importance scores. In other words, the analysis module 504 may perform some steps of the computer-implemented method as discussed in relation to FIG. 2. This module 504 may be configured to determine the prompt importance scores as discussed above in relation to FIG. 2. Module 504 may further be configured to determine if, and how many augmented prompts need to be obtained from respective reference prompts, as well as for how many target output sequences the prompt importance scores are to be determined. At least one prompt input sequence and target output sequence are obtained when determining the scores. Multiple target output sequences may be selected during the same analysis to smoothen the prompt importance scores. The obtained prompt importance scores allow evaluating the effectiveness of the input segments in the prompt 501, 502. Based on the outcome of this analysis, a decision module 505 may be configured to decide whether optimizing the augmentation is desirable or not.

To this end, module 504 may further be configured to perform determining whether to perform optimizing the augmentation of the prompt based on an effectiveness of the respective input segments in the prompt provided to the generative AI model. The effectiveness of an input segment is indicative for the number of input tokens that are included within the input segment relative to the number of output tokens affected by adjusting the input segment and the change in prompt importance score of these affected output tokens. Module 504 may further be configured to perform determining said effectiveness for one or more input segments of the prompt. Decision module 505 may then decide whether to perform optimizing of the augmentation based on this effectiveness.

If optimizing the augmentation is not required, the generated output sequence is provided as the final output 513. Else, the augmentation of the prompt is optimized by optimization engine 506. Existing optimization techniques can be used for this purpose. The applied technique will typically depend on the configuration of the prompt augmentation module 502 and its configuration parameters, as well as the phase in which the optimization is performed, i.e. during the development phase of the generative AI model 503 or during the deployment phase of the generative AI model 503. Optimization engine 506 may, for example, trigger an optimization of the respective augmentation modules 521-523 and/or the selection module 524. For example, if some prompt input segment provides limited value, the selection module 524 could be optimized to exclude this limited-value input segment in the augmented prompt to save compute resources. Alternatively or complementary, optimization engine 506 may trigger the initialization and/or training of an additional augmentation module 521-523 for producing an additional type of prompt segment input. The optimized settings and finetuned models of modules 521-524 may further be stored in a database 511. It will be apparent that, if modules 521-523 include multi-agent and/or iterative prompt augmentation modules, the optimization performed by engine 506 can also include selecting agents and/or optimizing the number of iterations.

The optimization by engine 506 may be performed on individual examples or on a plurality of examples. These examples may be labelled, i.e. where the desired target output(s) are known and provided, e.g. in the form of test cases during the development phase, or after manual labelling/correction during deployment phase. During the deployment phase, optimization may not occur during or after every new inference, but at intervals in time or if a possible dataset drift is detected, e.g. substantial changes in user inputs that need to be augmented that result in suboptimal prompt augmentation.

Optimizing for a plurality of examples is particularly advantageous for systematically and globally improving the overall efficiency and effectiveness of the prompt augmentation module 502 for future inferencing requests during the deployment phase. In other words, optimizing for a plurality of examples is particularly useful during the development phase of the generative AI model. This includes selecting, training, retraining, or finetuning heuristics and/or learned modules 521-524 within the prompt augmentation module 502 that are configured to select and format relevant prompt input segments.

Optimizing for individual examples is particularly advantageous to automatically reduce the number of iterations and/or prompt augmentation segments to be used during inference, i.e. during the deployment phase of the generative AI model. This is especially the case with iterative LLM-based models that need multiple iterations to come to a final response, e.g. multi-LLM agent systems or tree-of-thought chaining approaches, or in case there is a dynamic chain of LLM-based models, some or all requiring some level of prompt augmentation.

Optimizing for individual examples may also be particularly advantageous to automatically re-evaluate and update the type and amount of used prompt input segments. For example, when many output segments have a low average prompt importance score, this may indicate an insufficient or ineffective coverage of the prompt input segments with respect to the provided task. The prompt importance scores may also indicate that the LLM used the prompt input segments incorrectly, for example leaking detailed knowledge from the I/O examples into the final output, which would be undesirable in case the I/O examples are only to be used to encode the preferred format or style of the output.

Contrary to optimizing for a plurality of examples, optimizing for individual examples may include less substantial tuning operations of the augmentation modules 521-524, but may rather result in small variations based on the prompt importance scores as to which and how many prompt input segments to include. For example, in case the predicted output was not sufficiently covered or biased by the domain facts prompt input segment, the optimization engine 506 may instruct module 502 to include more facts. At the same time, it could also decide to include a shorter task description or even exclude it to avoid spending too many resources.

The optimization engine 506 may further be configured to interact with a database 508 for storing past optimization decisions and optimization learnings to avoid redundant optimization cycles for new inputs that are similar to previous inputs. This can avoid unnecessary optimization loops, thereby avoiding unnecessary consumption of computing resources.

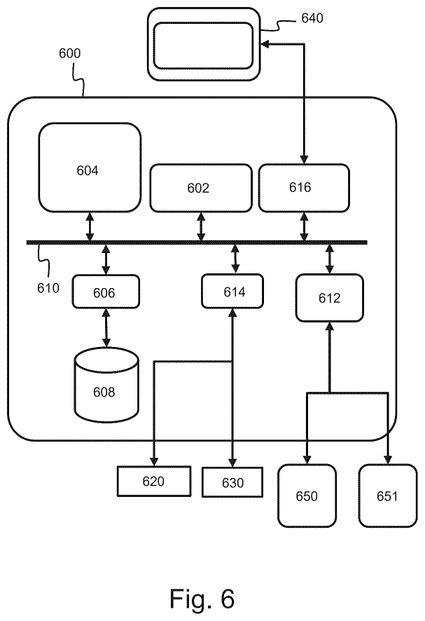

FIG. 6 shows a suitable computing system 600 enabling to implement embodiments of the computer-implemented method for optimizing an augmentation of a prompt. Computing system 600 may in general be formed as a suitable general-purpose computer and comprise a bus 610, a processor 602, a local memory 604, one or more optional input interfaces 614, one or more optional output interfaces 616, a communication interface 612, a storage element interface 606, and one or more storage elements 608. Bus 610 may comprise one or more conductors that permit communication among the components of the computing system 600. Processor 602 may include any type of conventional processor or microprocessor that interprets and executes programming instructions. Local memory 604 may include a random-access memory (RAM) or another type of dynamic storage device that stores information and instructions for execution by processor 602 and/or a read only memory (ROM) or another type of static storage device that stores static information and instructions for use by processor 602. Input interface 614 may comprise one or more conventional mechanisms that permit an operator or user to input information to the computing device 600, such as a keyboard 620, a mouse 630, a pen, voice recognition and/or biometric mechanisms, a camera, etc. Output interface 616 may comprise one or more conventional mechanisms that output information to the operator or user, such as a display 640, etc. Communication interface 612 may comprise any transceiver-like mechanism such as for example one or more Ethernet interfaces that enables computing system 600 to communicate with other devices and/or systems, for example with a queryable system 650 such as a database, or with a network node 651. The communication interface 612 of computing system 600 may be connected to such a source node or destination node by means of a local area network (LAN) or a wide area network (WAN) such as for example the internet. Storage element interface 606 may comprise a storage interface such as for example a Serial Advanced Technology Attachment (SATA) interface or a Small Computer System Interface (SCSI) for connecting bus 610 to one or more storage elements 608, such as one or more local disks, for example SATA disk drives, and control the reading and writing of data to and/or from these storage elements 608. Although the storage element(s) 608 above is/are described as a local disk, in general any other suitable computer-readable media such as a removable magnetic disk, optical storage media such as a CD or DVD, ROM, disk, solid state drives, flash memory cards, etc. could be used.

Although the present invention has been illustrated by reference to specific embodiments, it will be apparent to those skilled in the art that the invention is not limited to the details of the foregoing illustrative embodiments, and that the present invention may be embodied with various changes and modifications without departing from the scope thereof. The present embodiments are therefore to be considered in all respects as illustrative and not restrictive, the scope of the invention being indicated by the appended claims rather than by the foregoing description, and all changes which come within the scope of the claims are therefore intended to be embraced therein.

It will furthermore be understood by the reader of this patent application that the words “comprising” or “comprise” do not exclude other elements or steps, that the words “a” or “an” do not exclude a plurality, and that a single element, such as a computer system, a processor, or another integrated unit may fulfil the functions of several means recited in the claims. Any reference signs in the claims shall not be construed as limiting the respective claims concerned. The terms “first”, “second”, third”, “a”, “b”, “c”, and the like, when used in the description or in the claims are introduced to distinguish between similar elements or steps and are not necessarily describing a sequential or chronological order. Similarly, the terms “top”, “bottom”, “over”, “under”, and the like are introduced for descriptive purposes and not necessarily to denote relative positions. It is to be understood that the terms so used are interchangeable under appropriate circumstances and embodiments of the invention are capable of operating according to the present invention in other sequences, or in orientations different from the one(s) described or illustrated above.

1. A computer-implemented method for optimizing an augmentation of a prompt provided to a generative Artificial Intelligence, AI, model; wherein the prompt is an input sequence of input segments respectively comprising one or more input tokens; and wherein the generative AI model is configured to generate, from the prompt, an output sequence of output segments respectively comprising one or more output tokens; the computer-implemented method comprising:
obtaining at least one target output sequence for the prompt provided to the generative AI model;
obtaining one or more augmented prompts by adjusting one or more input segments with respect to at least one reference prompt;
determining prompt importance scores for the respective output segments of the at least one target output sequence; wherein a prompt importance score of a respective output segment is indicative for a change in probability of said output segment within the output sequence generated by the generative AI model as a result of adjusting the reference prompt; and
optimizing the augmentation of the prompt based on the prompt importance scores of the respective output segments.

2. The computer-implemented method according to claim 1, wherein the at least one target output sequence is a configuration instruction for configuring a network node or a controller.

3. The computer-implemented method according to claim 1, wherein the at least one target output sequence is a formatted query for interacting with a queryable system.

4. The computer-implemented method according to claim 1, wherein determining the prompt importance scores comprises, for each augmented prompt:
providing the augmented prompt and the at least one target output sequence to the generative AI model; and
obtaining the probabilities for the respective output segments of the target output sequence by extracting a measure of predicted likelihood associated with the respective output segments from the generative AI model.

5. The computer-implemented method according to claim 4, wherein the prompt importance score of a respective output segment is determined as the complement of a ratio of the probability of said output segment when providing the augmented prompt to the generative AI model, relative to the probability of said output segment when providing the reference prompt to the generative AI model.

6. The computer-implemented method according to claim 4, wherein the prompt importance score of a respective output segment is determined as an absolute difference between the probability of said output segment when providing the reference prompt to the generative AI model and the probability of said output segment when providing the augmented prompt to the generative AI model.

7. The computer-implemented method according to claim 4, wherein the prompt importance score of a respective output segment is determined as the relative probability of said output segment with respect to the highest probability of said output segment.

8. The computer-implemented method according to claim 1, wherein adjusting one or more input segments with respect to a reference prompt comprises omitting and/or reordering the one or more input segments of the reference prompt.

9. The computer-implemented method according to claim 1, wherein adjusting one or more input segments with respect to a reference prompt comprises sampling one or more input segments from a set of possible input segments; and adding or replacing the one or more input segments of the reference prompt with the one or more sampled input segments.

10. The computer-implemented method according to claim 1, further comprising determining an effectiveness of input segments based on the prompt importance scores; wherein the effectiveness of an input segment is indicative for the number of input tokens that are included within the input segment relative to the number of output tokens affected by augmenting the input segment and the change in prompt importance score of these affected output tokens.

11. The computer-implemented method according to claim 10, further comprising determining whether to perform optimizing the augmentation of the prompt based on the effectiveness of the respective input segments in the prompt provided to the generative AI model.

12. The computer-implemented method according to claim 1, wherein optimizing the augmentation of the prompt comprises at least one of improving the selecting of input segments from a set of possible input segments, improving the formatting of the input segments, improving the order of input segments in the input sequence of the prompt; tuning a model for generating an input segment; and/or initiating a model for generating an input segment.

13. The computer-implemented method according to claim 1, wherein the at least one target output sequence is the output sequence generated by the generative AI model when provided with the reference prompt, or the at least one target output sequence is a desired output sequence.

14. The computer-implemented method according to claim 1, wherein the reference prompt is a user provided prompt, an empty prompt, and/or a complete prompt comprising an ordered sequence of all input segments in a set of possible input segments wherefrom a prompt can be constructed.

15. An apparatus comprising at least one processor and at least one memory storing instructions that, when executed by the at least one processor, cause the apparatus to perform: optimize an augmentation of a prompt provided to a generative Artificial Intelligence, AI, model; wherein the prompt is an input sequence of input segments respectively comprising one or more input tokens; and wherein the generative AI model is configured to generate, from the prompt, an output sequence of output segments respectively comprising one or more output tokens; based on:
obtaining at least one target output sequence for the prompt provided to the generative AI model;
obtaining one or more augmented prompts by adjusting one or more input segments with respect to at least one reference prompt;
determining prompt importance scores for the respective output segments of the at least one target output sequence; wherein a prompt importance score of a respective output segment is indicative for a change in probability of said output segment within the output sequence generated by the generative AI model as a result of adjusting the reference prompt; and
optimizing the augmentation of the prompt based on the prompt importance scores of the respective output segments.

16. The apparatus according to claim 15, wherein the at least one target output sequence is a configuration instruction for configuring a network node or a controller.

17. The apparatus according to claim 15, wherein the at least one target output sequence is a formatted query for interacting with a queryable system.

18. The apparatus according to claim 15, wherein determining the prompt importance scores comprises, for each augmented prompt:
providing the augmented prompt and the at least one target output sequence to the generative AI model; and
obtaining the probabilities for the respective output segments of the target output sequence by extracting a measure of predicted likelihood associated with the respective output segments from the generative AI model.

19. The apparatus according to claim 18, wherein the prompt importance score of a respective output segment is determined as the complement of a ratio of the probability of said output segment when providing the augmented prompt to the generative AI model, relative to the probability of said output segment when providing the reference prompt to the generative AI model.

20. The apparatus according to claim 15, wherein the prompt importance score of a respective output segment is determined as an absolute difference between the probability of said output segment when providing the reference prompt to the generative AI model and the probability of said output segment when providing the augmented prompt to the generative AI model.
